(19) United States
(12) Patent Application Publication
(10) Pub. No.: US 2008/0032027 A1
(43) Pub. Date: Feb. 7, 2008

(54) Process for Making Jelly Containing Pectin

(75) Inventor: Joseph A. Petrella, San Diego, CA (US)

Correspondence Address: J M HUBER CORPORATION, 333 THORNALL STREET, PATENT DEPARTMENT, EDISON, NJ, 08837-2220, US

(73) Assignee: CP Kelco U.S., Inc, Atlanta, GA (US)

(21) Appl. No.: 11/462,752

(22) Filed: Aug. 7, 2006

(51) Int. Cl. A23L 1/05

(52) U.S. Cl. 426/573

(57) ABSTRACT

A process for making a fruit jelly comprising the steps of: (a) blending a pectin source with an aqueous fruit solution, at a temperature of less than 130° C., preferably less than 100° F., to form a base jelly product; and (b) adding a wet soluble solids solution to the base jelly product to form a fruit jelly.

### BACKGROUND OF THE INVENTION

A jelly is a confectionary product that includes soluble solids in the form of sugar and fruit juice, as well as pectin which imparts the eponymic function of gel formation. In conventional processes of making jelly the pectin is dispersed by use of a high-speed mixer into a low-solids aqueous jelly solution (i.e., a solids level of below 20% to 30%), the jelly solution being heated to and held at high temperature, e.g., from 170° F. to 180° F. This high temperature is necessary in order to fully solubilize the pectin, to prevent pregellation, as well as to ensure that the sugar component does not dissolve so rapidly that it can potentially lead to the formation of pectin lumps.

While high temperature processing of the pectin/jelly solution provides several processing advantages (as discussed above), the high temperature process also presents several problems. First, the high-temperature process requires an excess of water for effective solubilization (as mentioned above, the low-solids jelly solution has a solids concentration of no greater than 20% to 30%—the excess of this is water). This excess water must be removed at the expense of additional time and considerable cost. Second, many fruit and fruit concentrates to be used in jellied pastry products lose their zesty fresh taste when heated for a long time before pastry baking. Third, a considerable amount of additional time is expended in using this high temperature process. Not only must time be expended to raise the temperature of the jelly solution to high temperatures, but after completion of the process the jelly solution must be cooled for storage or for possible transport to a subsequent manufacturing stage where the jelly is incorporated in a fresh baked pastry product.

Cold temperature (e.g., standard room temperature) processes that do not require extensive heating have previously been developed using an alginate thickener. While these cold temperature processes obviate many of the aforementioned problems of high temperature processing, they also present additional new problems. In particular, alginates can impart an unpleasant flavor note related in its characteristic taste to the origin of alginates as extracts from brown seaweed. Furthermore, these cold temperature processes function only in a limited set of gel stabilizing systems, particularly systems based on calcium-induced gelling.

To address the disadvantages of the alginate-based cold temperature processes, pectin-containing cold temperature processes have recently been developed to stabilize fruit-containing paste systems. Such pectin stabilizing systems are disclosed in U.S. Pat. No. 6,706,306. However, at this point such pectin stabilizing systems are not suitable in jellies or with all types and species of pectins.

Fruit jellies are well known food compositions that are of such ease to make and prepare that they are often manufactured in a home kitchen. Jellies are composed of a hydrocolloid gelling agent (almost invariably pectin), an acid, sugar, and water-combined together within a ratio defined by a territorial agriculture authority or regulatory authority. Historically, jellies were most commonly used as spreads on breads and toast, but in recent years jellies have been increasingly incorporated into cereal and health bars and confectionary treats-making jellies even more important as a food item.

Accordingly, there is a need in the art for a pectin material suitable in jelly compositions and capable of solubilization in a cold temperature processes.

### BRIEF SUMMARY OF THE INVENTION

The present invention includes a process for making a fruit jelly comprising the steps of: (a) blending a pectin source with an aqueous fruit solution, at a temperature of less than 130° C., preferably less than 100° F., to form a base jelly product; and (b) adding a wet soluble solids solution to the base jelly product to form a fruit jelly.

The present invention further includes a process for making a fruit jelly comprising the steps of: (a) blending pectin extracted from citrus peels with an aqueous fruit solution, at a temperature of less than 130° C., preferably less than 100° F., to form a base jelly product; and (b) adding a wet soluble solids solution to the base jelly product to form a fruit jelly having at least 65 wt % soluble solids.

### DETAILED DESCRIPTION OF THE INVENTION

All parts, percentages and ratios used herein are expressed by weight unless otherwise specified. All documents cited herein are incorporated by reference.

The present invention is directed towards a process for making a jelly at lower temperatures than conventional jelly making processes. In the present invention it it is not required to heat the pectin to very high temperatures in order to completely solubilize it, which allows for the production of a jelly at lower temperatures thus reducing the cost of the process to the manufacturer while preserving in full the taste and texture of the jelly to the consumer.

Jelly

As mentioned above, a jelly is a confectionary product that includes soluble solids in the form of sugar and fruit juice as well as pectin and additional components such as acid and water. In the United States a “Jelly” is required by the U.S. Department of Agriculture to have at least 45 wt % of fruit component to each 55 wt % of sweetner solids, with the final soluble solids content of not less than 65%. (Requirements for Specific Standardized Fruit Butters, Jellies, Preserves, and Related Products, 21 C.F.R. § 150.140).

All of the aforementioned ingredients perform important functions in a jelly. The sugar and fruit juice, for example, provide the sweetness, taste and organoleptic texture and body that makes jelly a desirable spread for bread and pastries. As discussed above, the pectin provides gel formation, and in the case of HM pectins (which are the subject of the present application) this gel formation occurs in combination with the acid component as a consequence of the reduction of the pH of the jelly to a level at which a gel-system colloid is possible.

In the present invention a fruit jelly is made by blending a pectin source with an aqueous fruit solution, at a temperature of less than 130° C., preferably less than 100° F. to form a base jelly product. The aqueous fruit solution includes at least a fruit concentrate. A wet soluble solids solution is then added to the base jelly product to form a fruit jelly. This wet soluble solids solution includes at least one glucose syrup.

Each of these jelly ingredients will now be discussed in greater detail.

Fruit Juice Concentrates

In the present invention the fruit component is provided by one or more fruit juice concentrates. The amount of sugar found in the fruit juice concentrates is measured with a refractometer, and is given the unit “^{o}Brix”, or percent sugar. The fruit juice concentrate may be obtained from fruits such as apples, grapes, and berries by a variety of pressing and extraction techniques that are well-known to those or ordinary skill in the art.

Sugar Solids

The present invention preferably also includes glucose syrups (e.g., corn syrup) as a source of sugar sweetener solids. These glucose syrups are obtained by the acidic or enzymatic hydrolysis of corn starch. Low dextrose equivalent (“DE”) glucose syrups contain about 18% glucose, while higher DE glucose syrups such as about 60 DE would contain twice that amount of glucose. The glucose can be isomerized to give isofructose syrup (which has a distribution of 51% glucose, and 42% fructose) and high fructose glucose syrups (which have at least 95% fructose).

Glucose syrups may also used in the present invention as an important processing aid with pectin, when the pectin is not added as part of an aqueous solution; because when pectin is not added as part of a solution, there is the possibility that the pectin could stick to the sides of a mixing vessel to which it is added. To prevent this possibility, the pectin may be dispersed into a glucose syrup and this dispersion then added to the mixing vessel.

Acids

Another component of the present system is acid. Acid is added most importantly to reduce the pH to a range at which gelation occurs. However, acid is also added for other reasons; for example, to increase total acidity or to enhance certain fruit flavor notes. The suitable pH range depends on the final soluble solids level, but for the typical jelly product with soluble solids in the 65-68% concentration range, sufficient acid should be added to bring the pH into the 3.0 to 3.2 range; this is also the optimum pH range for the gelation performance of a “slow set” pectin, i.e., a HM pectin with a relatively low degree of esterfication, such as in the degree of esterfication range of 62-65%. For jellies with slightly higher soluble solids concentration such as in the 68-72% concentration range, sufficient acid should be added to reduce the pH to within the 3.1 to 3.3 range.

The acid used in the present invention may be selected from a wide variety of acids such as citric, malic, tartaric, lactic, fumaric, and phosphoric acids. Of the aforementioned acids, citric acid is the most preferred, because it provides excellent pH reduction while imparting smooth taste characteristics. However, it is also important to note that fruit juice concentrate itself has value as an acid and tend to lower pH. Typically the acid is provided in the form of a 50 wt % aqueous solution of citric acid.

Pectin

Pectins are natural materials that occur in most higher plant forms, forming the major structural components in the primary cell wall and middle lamella of young and growing plant tissues. The structure of pectin itself can be defined as 1,4-linked alpha-D-galactopyranosyluronic acid units in the ⁴C₁ conformation, with the glycosidic linkages arranged diaxially. One critical characteristic of the pectin structure that has a significant effect on the pectin's behavior and performance is what fraction of the carboxyl groups attached to the galactopyranosyluronic acid units are esterified with methanol. In commercial usage, pectins having a degree of esterification of less than 50% (i.e., less than 50% of the carboxyl groups are methylated to form methyl ester groups) are classified as low-ester pectins (or “LM-pectins”) while those pectins having a degree of esterficiation of greater than 50%, (i.e., more than 50% of the carboxyl groups are methylated) are classified as high-ester pectins (or “HM-pectins”). The present invention will relate primarily to HM-pectins. Preferably, the pectins of the present invention will have a DE of about 57% to about 66%.

The pectin manufacturer can, to some extent, control the DE of the pectin by appropriate processing steps and conditions well known to skilled persons. Pectin may be made from the peels of lemon, lime, or grapefruit (in the case of citrus pectin), or even from apples or sugar beets. Typically, the citrus and apple peel raw material are the by-products from fruit juice and fruit oil production. Conventionally, pectin is commercially produced by suspending pectin-rich plant tissue (the peels mentioned above) in warm acidified water for some time. This part of the pectin manufacturing is commonly referred to as the “extraction”; it converts the insoluble form of pectin as it exists in plants (often referred to as “protopectin”) to soluble pectin which then leaches into the solution. Later, the pectin is recovered from said solution by separation processes. If high DE is desired, normally less acid is used for the extraction as compared to the amount of acid used if lower DE is desired.

The DE can be further reduced by treating the pectin solution with acid or with an enzyme that de-esterifies pectin. Such enzymes, generically referred to as pectin esterases, are well known. The acid, as well as the enzymes, hydrolyse some of the methyl-esterified carboxyl groups producing non-esterified carboxyl groups and methanol. However, while acid and some enzymes apparently pick the carboxyl groups to be de-esterified either at random or in a regular way, other enzymes de-esterify in such a way that blocks of consecutive free carboxyl groups occur in the molecules. The latter enzymes occur naturally in citrus fruit and may to varying extent create blocks in the pectin before the extraction process. A pectin manufacturer can thus to some extent manipulate not only the DE, but also the “blockiness”. If a rather pronounced blockiness is desired this can be accomplished either by selecting a citrus raw material that has been affected by esterase (e.g., orange), by exposing the dissolved extracted pectin to a block-creating pectin esterase, or both. If blockiness is not desired, the manufacturer may select raw-material that has been less affected by esterase and use either acid or an enzyme, that does not create block, for reaching the desired DE.

The process of the present invention can be practiced according to methods well known to those of ordinary skill in the art and making use of standard laboratory cookware and mixers, however, on an industrial scale it is most conveniently practiced using specialized manufacturing equipment. Suitable mixers include the powder impeller mixer (also known as a “Tri-blender”) as described in U.S. Pat. No. 3,606,270.

The invention will now be described in more detail with respect to the following, specific, non-limiting examples.

### EXAMPLES

Jellies according to the present invention was prepared as follows.

### Example 1

A first jelly was prepared from the following ingredients in the weight concentrations set below.

TABLE I

| Ingredients | | Percent |
|---|---|---|
| (1) | Grape Juice Concentrate 68°brix | 10.50 |
| | Aqueous citric acid 50% solution | 1.20 |
| (2) | Tap water (70° F.) | 13.20 |
| | HFCS 42 | 5.00 |
| | GENU ® D Slow Set Z | 0.40 |
| | Sodium citrate 33% soln | 0.30 |
| (3) | Corn syrup 42 DE | 42.70 |
| | HFCS 42 | 26.20 |
| | Potassium sorbate 20% solution w/w | 0.50 |
| | Total | 100.00 |

The jelly was then made as follows. (1) First, grape juice concentrate was mixed with aqueous citric acid solution in a kettle and mixed well to form an aqueous fruit solution. (2) Second, pectin was dispersed into HFCS; an aqueous sodium citrate solution was further diluted with 70° F. tap water in a high shear mixing device, and then the pectin/HFCS dispersion was slowly added to the aqueous sodium citrate solution and the resulting mixture stirred for 3-4 minutes to form a pectin source solution. The pectin source solution was then added to the aqueous fruit solution to form a base jelly product. (3) Third, corn syrup 42 DE, HFCS and potassium sorbate solution were mixed together thoroughly to form a wet soluble solids solution. The wet soluble solids solution was then added to the base jelly product, mixed well, and then immediately filled into appropriate containers or jars. The final jelly compositions had a Brix of approximately 65-66° and a pH of between 3.0 and 3.2.

### Example 2

A second jelly was prepared from the following ingredients in the weight concentrations set below.

TABLE II

| Ingredients | | Percent |
|---|---|---|
| (1) | Concord Grape Juice Concentrate 68°brix | 10.5 |
| | Citric acid 50% solution w/w | 1.2 |
| (2) | HFCS 42% fructose | 5.0 |
| | GENU ® pectin type D Slow Set Z | 0.4 |
| (3) | Tap water (70° F.) | 13.2 |
| | Sodium citrate 33% solution w/w | 0.3 |
| (4) | Corn syrup 42 DE | 42.7 |
| | HFCS 42% fructose | 26.2 |
| | Potassium sorbate 20% solution w/w | 0.5 |
| | Anti-foam (Dow) | 0.01 |
| | Total | 100.00 |

The Jelly was made in accordance with steps (1)-(4) in Table II above. First, the fruit juice concentrate and 50% citric acid solution was combined, then thoroughly mixed together to form an aqueous fruit solution. Then a 3% pectin source solution was prepared by adding water and sodium citrate solution to a high shear mixing device (waring/vortex type) commencing agitation, and then slowly adding an pectin/HFCS dispersion into the vortex. The resulting pectin solution was then mixed for 3-4 minutes, at which time the aqueous fruit solution was added and the resulting material mixed well to form a base jelly product. The corn syrup, HFCS and potassium sorbate solution were then mixed together to form a wet soluble solids solution, and then added to the base jelly product. The resulting material was then mixed well and anti-foam added. The final product was then filled immediately into appropriate containers or jars.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for making a fruit jelly comprising the steps of:
(a) blending a pectin source with an aqueous fruit solution, at a temperature of less than 130° C., preferably less than 100° F., to form a base jelly product; and
(b) adding a wet soluble solids solution to the base jelly product to form a fruit jelly.

2. The process according to claim 1, whereby the addition of the wet soluble solids solution to the base jelly initiates gelling of the base jelly product.

3. The process according to claim 2, wherein the wet soluble solids is in the form of one or more glucose syrups.

4. The process according to claim 1, wherein the pectin source includes pectin extracted from citrus peels.

5. The process according to claim 1, wherein the fruit jelly has a pH of from about 3.0 to about 3.2.

6. The process according to claim 1, wherein the process further comprises adding an acid to the base jelly product.

7. The process according to claim 6, wherein the acid is selected from the group consisting of citric, malic, tartaric, lactic, fumaric, and phosphoric acids.

8. The process according to claim 1, wherein the fruit jelly contains at least 65 wt % soluble solids.

9. The process according to claim 1, wherein the pectin source includes a pectin with a DE of from about 55% to about 65%.

10. A process for making a fruit jelly comprising the steps of:
(a) blending pectin extracted from citrus peels with an aqueous fruit solution, at a temperature of less than 130° C., preferably less than 100° F., to form a base jelly product; and
(b) adding a wet soluble solids solution to the base jelly product to form a fruit jelly having at least 65 wt % soluble solids.

11. The process according to claim 10, wherein the process further comprises adding an acid to the base jelly product.

12. The process according to claim 10, wherein the acid is selected from the group consisting of citric, malic, tartaric, lactic, fumaric, and phosphoric acids.
